(19) United States
(12) Patent Application Publication
(10) Pub. No.: US 2006/0190890 A1
(43) Pub. Date: Aug. 24, 2006

(54) Cell instance generating method

(76) Inventors: Masahiro Ohashi, Kasuya-Gun (JP); Takahiro Kondo, Fukuoka (JP)

Correspondence Address: WENDEROTH, LIND & PONACK L.L.P., 2033 K. STREET, NW, SUITE 800, WASHINGTON, DC, 20006, US

(21) Appl. No.: 11/339,736

(22) Filed: Jan. 26, 2006

(30) Foreign Application Priority Data
Jan. 27, 2005 (JP) 2005-020098

(51) Int. Cl. G06F 17/50

(52) U.S. Cl. 716/9

(57) ABSTRACT

By a hierarchical structure developing process at Step S1, layout pattern data possessing hierarchical structure is developed to flat layout pattern data. An optimizing process at Step S2 generates optimized flat layout pattern data accompanying a new inserted cell. By a hierarchical structure cell instance allotting process at Step S3, optimized flat layout pattern data is generated, in which an instance possessing hierarchical structure is allotted to the new inserted cell.

### BACKGROUND OF THE INVENTION

1. Field of the Invention

The present invention relates to a CAD (Computer Aided Design) system operable to automatically optimize cells in layout pattern data of a semiconductor integrated circuit, more specifically relates to a cell instance generating method by which a cell instance indicating hierarchical structure is allotted to a new cell inserted as a result of the optimization in creating hierarchical structure for each cell.

2. Description of the Related Art

In order to facilitate efficient development of increasingly larger-scale semiconductor integrated circuits, a method which extracts circuit connection data hierarchically from layout pattern data possessing hierarchical structure is widely used. As a prior art, Document 1 (Published Japanese patent application No. H07-121594) discloses a method which extracts hierarchical structure of each cell included in a semiconductor integrated circuit. According to Document 1, when extracting hierarchical structure for each cell, the layout pattern data possessing the hierarchical structure is fully developed to a flat layout pattern, from which flat circuit connection data is extracted. Then, an initial hierarchical structure possessing sub-circuits is generated from the flat circuit connection data, corresponding to the hierarchical structure of the layout pattern data.

Furthermore, a schematic diagram corresponding to elements in the circuit connection data and a schematic diagram of a base layer of the layout pattern data are compared, and then each element is assigned to the sub-circuits of the circuit connection data.

Moreover, an external connection net is specified to each of the sub-circuits. The identity of each of the sub-circuits is judged. When a same identity is found among the sub-circuits, then one of the sub-circuits is identified as a representative sub-circuit and the other sub-circuits are replaced with the representative sub-circuit, thereby the hierarchical structure of each cell is extracted.

FIG. 12 is a flow chart of a conventional extracting method for circuit connection data that possesses the hierarchical structure, disclosed in Document 1.

The conventional art is explained in the following, referring to FIG. 12.

At Processing 1 shown in FIG. 12, layout pattern data of a semiconductor integrated circuit, which possesses a hierarchical structure, is fully developed to data of cells to generate flat layout pattern data.

At Processing 2, elements and connection information among the elements are extracted from the fully developed layout pattern data, and flat connection information that is expressed by the layout pattern data is acquired. The extracted circuit connection data and the layout pattern data are correlated mutually and stored in a circuit connection file.

At Processing 3, an initial hierarchical structure of the circuit connection data possessing sub-circuits (a structure showing reference relationship among the sub-circuits) is generated. In this case, the hierarchal structure of the generated circuit connection data is a kind of hierarchical structure which would be generated when a cell identifier is replaced with an instance identifier in the hierarchical structure of the original layout pattern data. Here, the instances in the original hierarchical structure are used as the sub-circuits for convenience. Moreover, each of the sub-circuits has the cell identifier in the original structure as additional information.

At Processing 4, a base layer of the layout pattern data possessing the hierarchical structure is fully developed to data of cells to generate schematic diagram data of the base layer. (The created schematic diagram data in the present processing is used when assigning elements of the circuit connection data to each of the sub-circuits at the following processing.) Here, to the schematic diagram data of the base layer (equivalent to the layout pattern data), the instance identifier, to which the schematic diagram belongs in the hierarchical structure of the original layout pattern data, is individually given as the additional information.

At Processing 5, each of the elements of the flat circuit connection data extracted at Processing 2 is assigned to each of the sub-circuits which constitute the initial hierarchical structure generated at Processing 3.

At Processing 6, external connection nets of the sub-circuits are specified.

At Processing 7, a redundant part among the sub-circuits, which may exist in the circuit connection data acquired at processes up to Processing 6, is eliminated.

Performing these processes makes it possible to extract the circuit connection data hierarchically and the net list showing the hierarchical structure.

As explained above, the following two items, (a) and (b), must be performed for extracting the hierarchical structure in the conventional method; (a) an initial hierarchical structure needs to be generated, and (b) the schematic diagram correlated to each of the elements of the flat circuit connection data and the schematic diagram of the fully developed base layer need to be compared with each other. Such items to be performed are accompanied with resultantly increased processing amount in extracting the hierarchical structure. Moreover, when an optimizing process is performed to flat layout pattern data, an instance can not be allotted to an optimized cell or an inserted cell. Thereby, it is difficult to perform area assessment and power consumption analysis in a hierarchical structure unit, by using the net list generated from the flat layout data.

### OBJECTS AND SUMMARY OF THE INVENTION

An object of the present invention is to provide a cell instance generating method operable to accurately and uniquely allot a cell instance indicating hierarchical structure to a new cell inserted as a result of optimizing flat layout pattern data, which is developed from layout pattern data possessing hierarchical structure.

In the following description, “an upper stream cell (or a down stream cell)” means “a cell which is connected, directly or indirectly via another cell, to the concerned cell at the input port (or the output port) thereof. The words “upper stream” and “down stream” are used in equivalence to the words “input side” and “output side”, in the description of the present invention.

A first aspect of the present invention provides a cell instance generating method comprising: developing data of a hierarchically constructed layout pattern into data of cells, thereby generating data of a flat layout pattern including the data of cells; optimizing the data of the flat layout pattern, thereby generating data of an optimized flat layout pattern including a newly inserted first cell having an input port and an output port. The input port of the first cell is connected to a second cell of the optimized flat layout pattern, the output port of the first cell is connected to a third cell of the optimized flat layout pattern, and at least one of the second cell and the third cell has a hierarchical structure cell instance indicating a hierarchical structure thereof. The cell instance generating method further comprises: quoting either of the hierarchical structure cell instance of the second cell or the hierarchical structure cell instance of the third cell, thereby generating a cell instance to be allotted to the first cell; and allotting the generated cell instance to the first cell.

According to the method, a cell instance indicating hierarchical structure can be uniquely allotted to a new inserted cell after optimizing the flat layout pattern data, by quoting the instance of a cell connected to either the input port or the output port of the new inserted cell. As a result, all cells become detectable in the hierarchical structure unit by specifying the instance of the net list generated from the flat layout pattern data.

A second aspect of the present invention provides the cell instance generating method as defined in the first aspect, wherein when the second cell does not possess a hierarchical structure cell instance, the quoting includes quoting a cell instance of a further upper stream cell, thereby generating a cell instance to be allotted to the first cell.

A third aspect of the present invention provides the cell instance generating method as defined in the first aspect, wherein when the third cell does not possess a hierarchical structure cell instance, the quoting includes quoting a cell instance of a further down stream cell, thereby generating a cell instance to be allotted to the first cell.

According to these methods, it is possible to allot, accurately and uniquely, a hierarchical structure cell instance to each of all the new cells inserted as a result of the optimization of the flat layout pattern data.

A fourth aspect of the present invention provides a cell instance generating method comprising: developing data of a hierarchically constructed layout pattern into data of cells, thereby generating data of a flat layout pattern including the data of cells; optimizing the data of the flat layout pattern, thereby generating data of an optimized flat layout pattern including a newly inserted first cell group having an input port and an output port. The input port of the first cell group is connected to a second cell group of the optimized flat layout pattern, and the output port of the first cell group is connected to a third cell group of the optimized flat layout pattern. The cell instance generating method further comprises: quoting either of a hierarchical structure cell instance of a cell belonging to the second cell group or a hierarchical structure cell instance of a cell belonging to the third cell group, thereby generating a cell instance to be allotted to a cell belonging to the first cell group; and allotting the generated cell instance to the cell belonging to the first cell group.

According to the method, for any combination of a case where the first cell group is composed of one or more newly inserted cells, a case where the second cell group is composed of one or more cells, and a case where the third cell group is composed of one or more cells, it is possible to allot, accurately and uniquely, a hierarchical structure cell instance to each of all the new cells in the first cell group.

A fifth aspect of the present invention provides the cell instance generating method as defined in the fourth aspect, wherein when at least one of the second cell group and the third cell group is composed of a plurality of cells connected to the first cell group, the quoting includes quoting a hierarchical structure cell instance of a cell chosen from the plurality of cells in accordance with a predetermined rule, thereby generating a cell instance to be allotted to a cell belonging to the first cell group.

According to the method, when a plurality of cells are included in either of the second cell group or the third cell group, a cell to be quoted can be uniquely selected among the plurality of cells by following the predetermined rule. Therefore, the hierarchical structure cell instance can be allotted to the new inserted cell.

A sixth aspect of the present invention provide the cell instance generating method as defined in the fifth aspect, wherein the predetermined rule includes a rule quoting a hierarchical structure cell instance from a plurality of hierarchical structure cell instances of the plurality of cells, in accordance with at least one of an alphabetical order, a numerical order, and a character code order.

According to the method, even when a plurality of cells are included in either of the second cell group or the third cell group, a hierarchical structure cell instance to be quoted can be uniquely determined among the plurality of hierarchical structure cell instances, by following a simple rule, such as an alphabetical order, a numerical order, and a character code order, and so on. Thereby, the hierarchical structure cell instance can be uniquely allotted to the new inserted cell.

A seventh aspect of the present invention provides the cell instance generating method as defined in the fifth aspect, wherein the predetermined rule includes a rule quoting a hierarchical structure cell instance of a cell of the plurality of cells, in accordance with at least one of a wire length and a connection capacity between the first cell group and the cell of the plurality of cells.

According to the method, even when a plurality of cells are included in either of the second cell group or the third cell group, a hierarchical structure cell instance to be quoted can be uniquely determined among the plurality of hierarchical structure cell instances, by following a simple rule in terms of a wire length and a connection capacity between the concerned cell and the new inserted cell. The concerned cell may possess the shortest wire length (or conversely, the longest wire length) and/or the largest connection capacity (or conversely, the smallest connection capacity).

An eighth aspect of the present invention provides the cell instance generating method as defined in the fifth aspect, wherein the predetermined rule includes choosing either of the second cell group and the third cell group based on a number of cells included therein and quoting a hierarchical structure cell instance of a cell belonging to the chosen cell group.

According to the method, the predetermined rule is given in terms of comparative smallness (or largeness) in the number of the plurality of cells included in the second and third cell groups, thereby enabling a unique quotation of the hierarchical structure cell instance.

A ninth aspect of the present invention provides the cell instance generating method as defined in the fourth aspect, wherein when the first cell group is composed of a plurality of cells chained one another, the quoting includes: dividing the plurality of cells composing the first cell group into an upper stream group and a down stream group at a predetermined ratio; quoting a hierarchical structure cell instance of a cell belonging to the second cell group, thereby generating a cell instance to be allotted to a cell belonging to the upper stream group; and quoting a hierarchical structure cell instance of a cell belonging to the third cell group, thereby generating a cell instance to be allotted to a cell belonging to the down stream group.

According to the method, the plurality of new inserted cells chained one another of the first cell group are divided into an upper stream group and a down stream group at a predetermined ratio (for example at 50 to 50). The cell belonging to the upper stream group is allotted a cell instance quoting the hierarchical structure cell instance of a cell belonging to the second cell group, and the cell belonging to the down stream group is allotted a cell instance quoting the hierarchical structure cell instance of a cell belonging to the third cell group. Thereby, all chained cells in the first group can be uniquely allotted their hierarchical structure cell instances.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a flow chart of cell instance generation in Embodiment 1 of the present invention;

FIG. 2 is an exemplified schematic diagram illustrating layout pattern data possessing hierarchical structure in Embodiment 1 of the present invention;

FIG. 3 is an exemplified schematic diagram illustrating optimized flat layout pattern data (in an intermediate state) with allotted hierarchical structure cell instances in Embodiment 1 of the present invention;

FIG. 4 is a flow chart of cell instance generation of a new inserted cell in Embodiment 1 of the present invention;

FIG. 5 is a flow chart of cell instance generation in Embodiment 1 of the present invention;

FIG. 6 is an exemplified schematic diagram illustrating optimized flat layout pattern data (in a completed state) with allotted hierarchical structure cell instances in Embodiment 1 of the present invention;

FIG. 7 is a partial exemplified schematic diagram illustrating optimized flat layout pattern data (in an intermediate state) with allotted hierarchical structure cell instances in Embodiment 2 of the present invention;

FIG. 8 is a flow chart of cell instance generation in Embodiment 2 of the present invention;

FIG. 9 is a partial exemplified schematic diagram illustrating optimized flat layout pattern data (in an intermediate state) with allotted hierarchical structure cell instances in Embodiment 3 of the present invention;

FIG. 10 is a flow chart of cell instance generation in Embodiment 3 of the present invention;

FIG. 11 is a partial exemplified schematic diagram illustrating optimized flat layout pattern data (in an intermediate state) with allotted hierarchical structure cell instances in Embodiment 4 of the present invention;

FIG. 12 is a flow chart of a conventional extracting method for circuit connection data that possesses hierarchical structure.

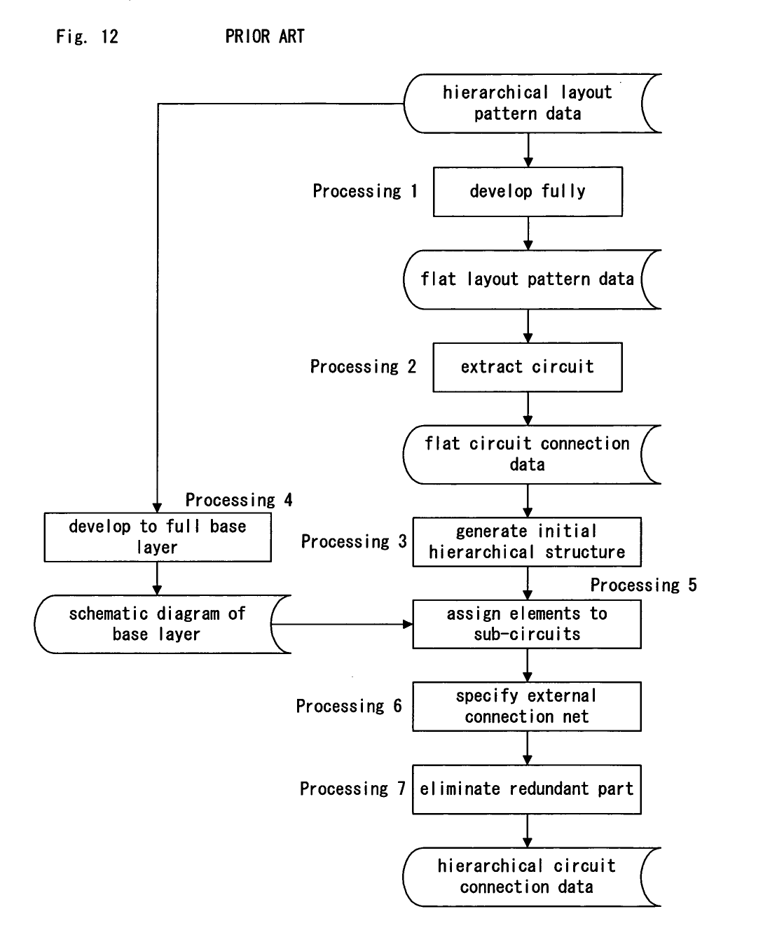

### DETAILED DESCRIPTION OF THE PREFERRED EMBODIMENTS

The embodiments of the present invention are explained referring to accompanying drawings.

### Embodiment 1

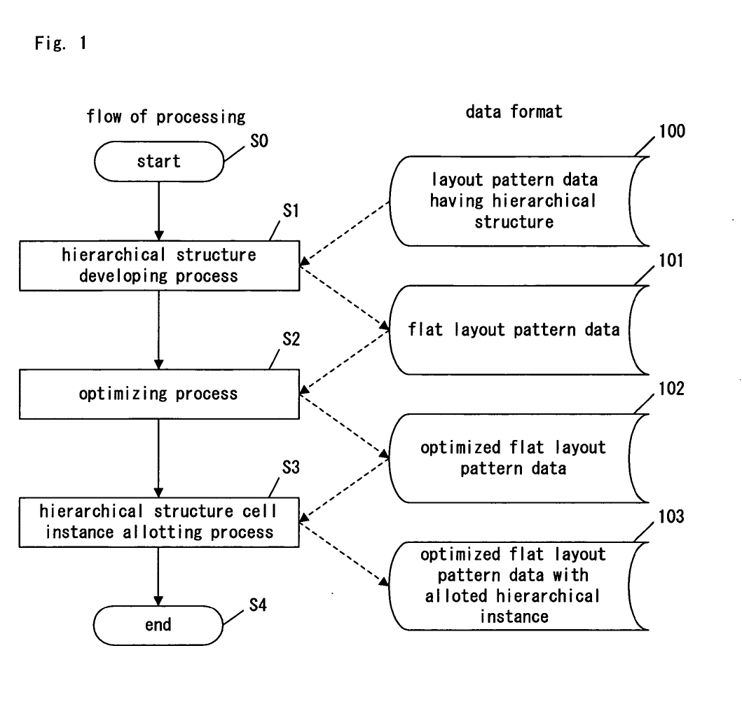

FIG. 1 is a flow chart of cell instance generation in Embodiment 1 of the present invention. Referring to the figure, the cell instance generating method of the present embodiment is explained in the following.

The left side of FIG. 1 shows the flow of the processing, and the right side of the figure shows the data formats of the layout pattern data that are inputted and outputted in each processing state.

According to FIG. 1, the outline of the cell instance generating method of the present embodiment is explained first.

When the processing starts at Step S0, a hierarchical structure developing process is performed to layout pattern data 100 at Step S1, and flat layout pattern data 101 is generated.

At Step S2, an optimizing process is performed to the flat layout pattern data 101, and optimized flat layout pattern data 102 is generated. By the process, a cell or more cells are newly inserted, in addition to the existing cells. The number of the new inserted cells depends on the case.

At Step S3, a hierarchical structure cell instance allotting process is performed to the optimized flat layout pattern data 102. At this time, an instance possessing hierarchical structure (hereinafter, it is called as a hierarchical structure cell instance) is first allotted to each of the existing cells. Then, according to the cell instance generating method of the present invention, a hierarchical structure cell instance is allotted to the cell(s) newly inserted at Step S2. As a result of the hierarchical structure cell instance allotment to all of the cells, optimized flat layout pattern data 103 is generated.

A series of the process is completed at Step S4.

The cell instance generating method of the present embodiment explained above describes for the layout pattern data on the layout flow chart. The cell instance generating method of the present invention is not limited to the case, but can be equally applied to the net list after completing the layout flow. More specifically, the hierarchical structure cell instance allotting process at Step S3 shown in FIG. 1 can be performed to the net list after completing the layout flow, with the same processing result as described above.

Next, the cell instance generating method of the present embodiment is explained using a more detailed example.

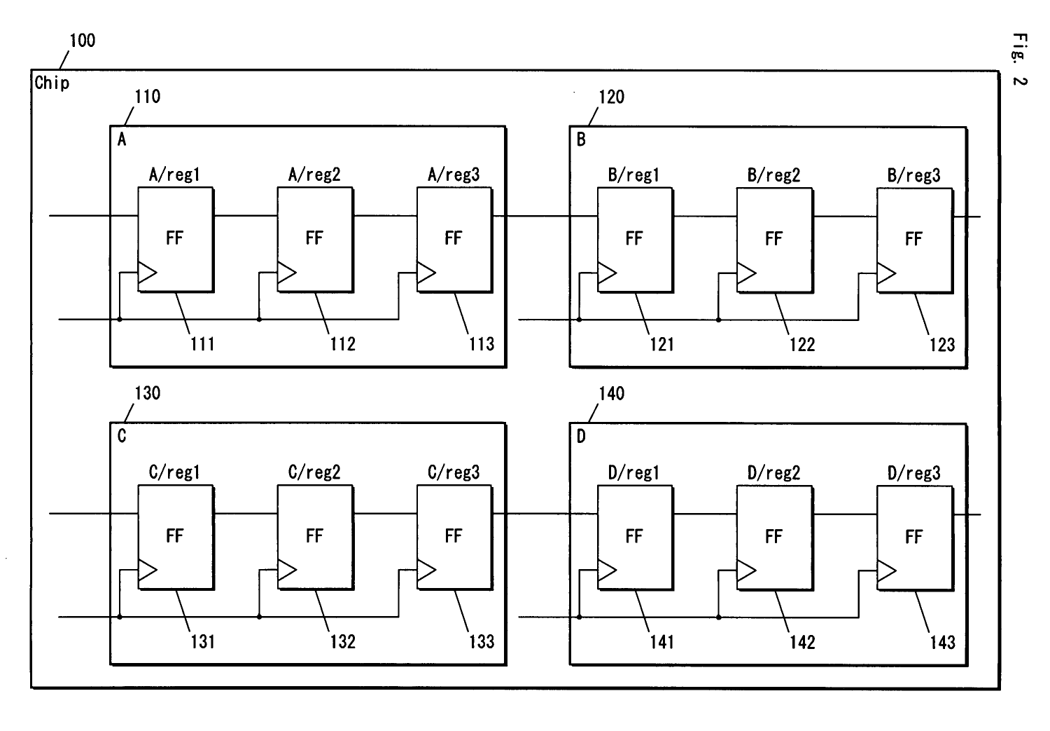

FIG. 2 is an exemplified schematic diagram illustrating layout pattern data possessing hierarchical structure in Embodiment 1 of the present invention.

In the layout pattern data 100 possessing the hierarchical structure shown in FIG. 2, there are four cells under a top layer cell Chip: a cell A 110, a cell B 120, a cell C 130, and a cell D 140. Furthermore, there are flip-flops 111, 112, and 113 under the cell A 110; flip-flops 121, 122, and 123 under the cell B 120; flip-flops 131, 132, 133 under the cell C 130; and flip-flops 141, 142, 143 under the cell D 140. In other words, the layout pattern data 100 possesses three-layered structure.

Each cell shown in FIG. 2, which is a structural element of the layout pattern data 100 of the three-layered structure, is allotted an instance per layer,

Specifically,

an instance of the cell Chip is an instance “Chip”;

an instance of the cell A 110 is an instance “A”;

an instance of the cell B 120 is an instance “B”;

an instance of the cell C 130 is an instance “C”; and

an instance of the cell D 140 is an instance “D.”

As for the cells included in the second layer cell A 110:

an instance of the flip-flop 111 is an instance “A/reg1”;

an instance of the flip-flop 112 is an instance “A/reg2”; and

an instance of the flip-flop 113 is an instance “A/reg3.”

As for the cells included in the second layer cell B 120:

an instance of the flip-flop 121 is an instance “B/reg1”;

an instance of the flip-flop 122 is an instance “B/reg2”; and

an instance of the flip-flop 123 is an instance “B/reg3.”

As for the cells included in the second layer cell C 130:

an instance of the flip-flop 131 is an instance “C/reg1”;

an instance of the flip-flop 132 is an instance “C/reg2”; and

an instance of the flip-flop 133 is an instance “C/reg3.”

As for the cells included in the second layer cell D 140:

an instance of the flip-flop 141 is an instance “D/reg1”;

an instance of the flip-flop 142 is an instance “D/reg2”; and

an instance of the flip-flop 143 is an instance “D/reg3.”

The instances per hierarchal layer of every cell, as described above, are shown in FIG. 2.

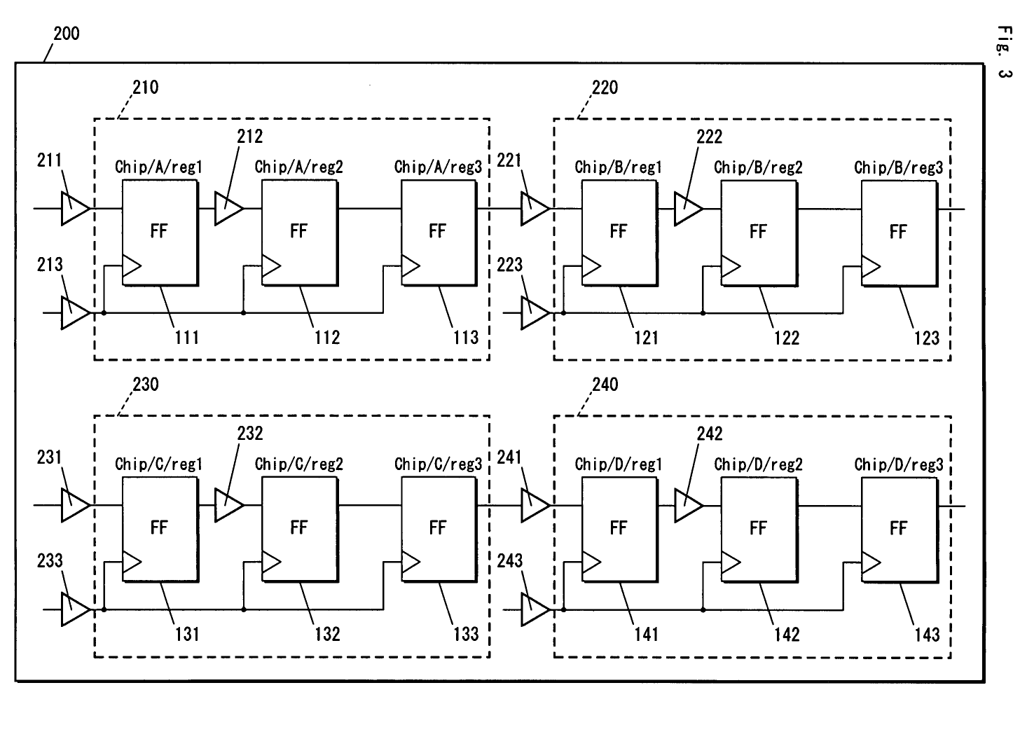

To the layout pattern data 100 possessing the hierarchical structure shown in FIG. 2, the hierarchical structure developing process of Step S1 and the optimizing process of Step S2, shown in FIG. 1, are performed. Furthermore, when the hierarchical structure cell instance allotting process of Step S3 shown in FIG. 1 is performed to the existing cells except for the new inserted cell(s), optimized flat layout pattern data 200 shown in FIG. 3 can be obtained as the layout pattern data in an intermediate state, after the hierarchical structure cell instance is allotted.

FIG. 3 is an exemplified schematic diagram illustrating optimized flat layout pattern data 200 (in an intermediate state) with allotted hierarchical structure cell instance in Embodiment 1 of the present invention. In FIG. 3, the same symbols are given to the same components as the FIG. 2.

In the optimized flat layout pattern data 200 shown in FIG. 3, the cell A 110, the cell B 120, the cell C 130, and the cell D 140 shown in FIG. 2 do not exist any more. (In FIG. 3, the cells that have constituted them are surrounded by dotted-line frames 210, 220, 230, and 240.) In return, by the hierarchical structure cell instance allotting process, an instance added with a top layer instance “Chip”, as a hierarchical structure cell instance, is allotted to each existing cells, as follows.

As for cells included in the second layer cell A 110, the following hierarchical structure cell instance is allotted:

an instance “Chip/A/reg1” to the flip-flop 111;

an instance “Chip/A/reg2” to the flip-flop 112; and

an instance “Chip/A/reg3” to the flip-flop 113.

As for cells included in the second layer cell B 120, the following hierarchical structure cell instance is allotted:

an instance “Chip/B/reg1” to the flip-flop 121;

an instance “Chip/B/reg2” to the flip-flop 122; and

an instance “Chip/B/reg3” to the flip-flop 123.

As for cells included in the second layer cell C 130, the following hierarchical structure cell instance is allotted:

an instance “Chip/C/reg1” to the flip-flop 131;

an instance “Chip/C/reg2” to the flip-flop 132; and

an instance “Chip/C/reg3” to the flip-flop 133.

As for cells included in the second layer cell D 130, the following hierarchical structure cell instance is allotted:

an instance “Chip/D/reg1” to the flip-flop 141;

an instance “Chip/D/reg2” to the flip-flop 142; and

an instance “Chip/D/reg3” to the flip-flop 143.

As mentioned above, new cells are inserted by the optimizing process of step S2 shown in FIG. 1. In the optimized flat layout pattern data 200 shown in FIG. 3, as new cells for timing adjustment and drive capability improvement, buffers 211, 212, 221, 222, 231, 232, 241, and 242 are inserted, and as new cells for clock skew adjustment, buffers 213, 223, 233, and 243 are inserted.

In the prior art, independent instances were allotted to these new inserted buffers, without performing the hierarchical structure cell instance allotting process as shown in step S3 of FIG. 1. For example, instances dbuf1, dbuf2, dbu3, dbuf4, dbuf5, dbuf6, dbuf7, and dbuf8 are respectively allotted to the buffers 211, 212, 221, 222, 231, 232, 241, and 242, which have been inserted as the new cells for the timing adjustment and the drive capability improvement. Instances cbuf1, cbuf2, cbuf3, and cbuf4 are respectively allotted to the buffers 213, 223, 233, and 243, which have been inserted as the new cells for the clock skew adjustment. As a result, the instance of each of the new inserted cells does not possess hierarchical structure which indicates an upper layer to which each of the new inserted cells belongs.

On the contrary, by the cell instance generating method of the present invention, the cell instance indicating hierarchical structure (the hierarchical structure cell instance) is allotted to all of the new cells that are inserted by the optimizing process of Step S2 shown in FIG. 1.

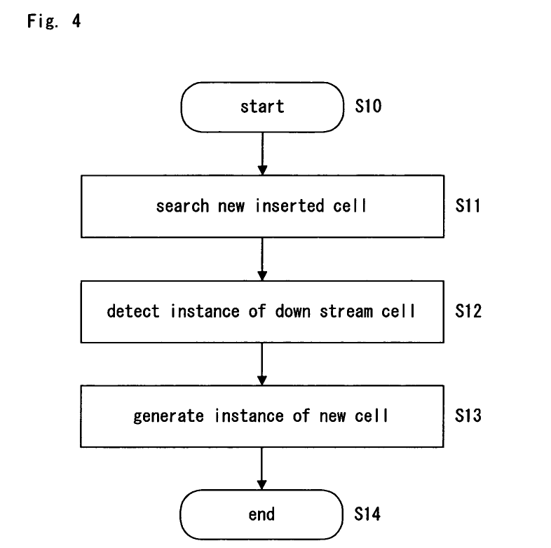

FIG. 4 is a flow chart of cell instance generation of a new inserted cell in Embodiment 1 of the present invention. In the cell instance generating method of the present embodiment, the instance is generated to allot to the new inserted cell, by quoting the instance of a cell in the down stream of the new inserted cell.

In other words, at Step S10 shown in FIG. 4, when the hierarchical structure cell instance allotting process starts, a new inserted cell is searched at Step S11.

At Step S12, a cell in the down stream of the new inserted cell is searched, and the instance of the cell is detected.

At Step S13, the detected instance is imparted to the instance of the new inserted cell, thereby generating a new hierarchical structure cell instance and allotting it to the new inserted cell. The processing ends at Step S14.

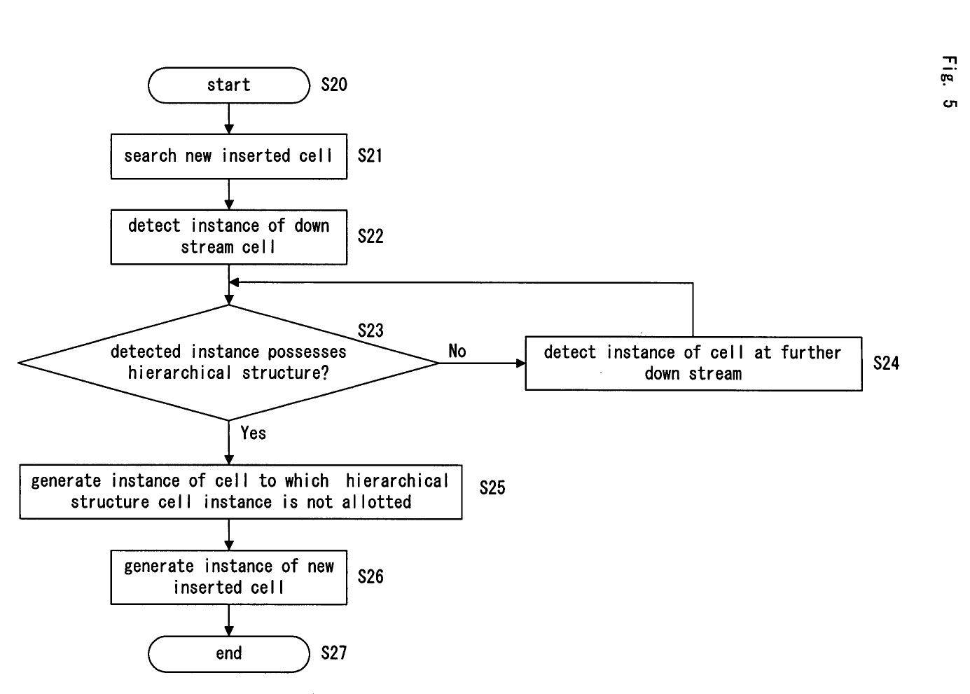

In the flow chart of the cell instance generation for the new inserted cell shown in FIG. 4, the cell in the down stream of the new inserted cell may not possess an instance that indicates hierarchical structure. In this case, according to the flow chart shown in FIG. 5, a cell which is located at further down stream is searched.

FIG. 5 is a flow chart of the cell instance generation in Embodiment 1 of the present invention.

At Step S20 shown in FIG. 5, when the hierarchical structure cell instance allotting process starts, a new inserted cell is searched at Step S21.

At Step S22, the instance of a cell in the down stream of the searched new inserted cell is detected.

At Step S23, whether the detected instance is a hierarchical structure cell instance or not is judged. When the judgment result is “Yes” (it is the hierarchical structure cell instance), the control moves to Step S25. When the judgment result is “No” (it is not the hierarchical structure cell instance), the control moves to Step S24.

At Step S24, a cell located at further down stream than the cell of which the instance has been detected and judged at Step 23 is searched, and the instance of the searched cell is detected. Then, the control returns to Step S23.

By repeating Step S23 and Step S24, a cell, to which the hierarchical structure cell instance is allotted, is finally reached.

At Step S25, a hierarchical structure cell instance is generated and allotted to each of the cells without the hierarchical structure cell instance, located between the new inserted cell and the cell in which the hierarchical structure cell instance is finally detected at Step S24.

At Step S26, a hierarchical structure cell instance for the new inserted cell is generated and allotted to the new inserted cell. The processing ends at Step S27.

By the above-mentioned processing, even when the hierarchical structure cell instance is not allotted to the cell in the down stream of the new inserted cell, it is possible to generate the hierarchical structure cell instance to allot to the new inserted cell.

When the cell instance generating method of the present embodiment is performed according to the flow charts of FIG. 4 and FIG. 5, hierarchical structure cell instances are allotted to all of the new inserted cells in the optimized flat layout pattern data 200 shown in FIG. 3.

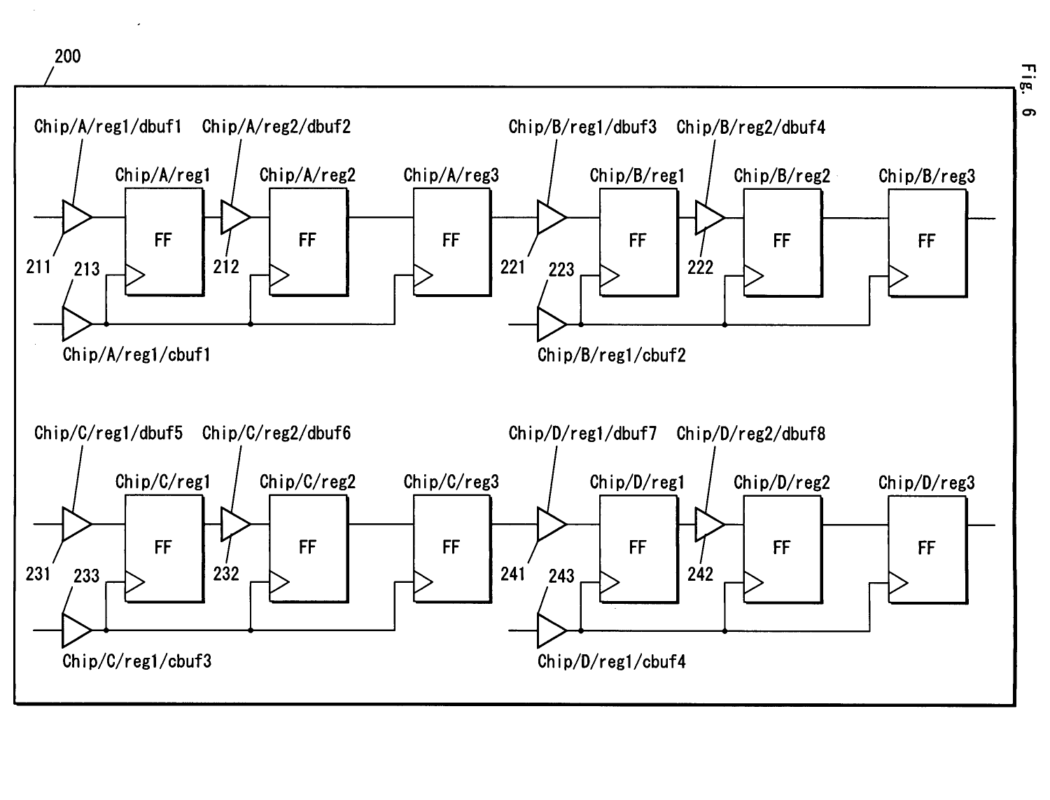

FIG. 6 is an exemplified schematic diagram illustrating optimized flat layout pattern data with allotted hierarchical structure cell instances in Embodiment 1 of the present invention. FIG. 6 shows the state where the hierarchical structure cell instance allotting process is completed.

Referring to FIG. 6, the hierarchical structure cell instances allotted to the new inserted cells are shown in detail in the following.

As for the buffers 211 to 242, newly inserted for the timing adjustment and drive capability improvement, the following hierarchical structure cell instances are allotted:

an instance “Chip/A/reg1/dbuf1” to the buffer 211;

an instance “Chip/A/reg2/dbuf2” to the buffer 212;

an instance “Chip/B/reg1/dbuf3” to the buffer 221;

an instance “Chip/B/reg2/dbuf4” to the buffer 222;

an instance “Chip/C/reg1/dbuf5” to the buffer 231;

an instance “Chip/C/reg2/dbuf6” to the buffer 232;

an instance “Chip/D/reg1/dbuf7” to the buffer 241; and

an instance “Chip/D/reg2/dbuf8” to the buffer 242.

Each output of the buffers 213, 223, 233, and 243, which is newly inserted for the clock skew adjustment, is connected to a plurality of cells in the respective down stream. In this case, the cell instance generating method of the present embodiment generates hierarchical structure cell instances for the new inserted cells, by quoting the instance of each of the plurality of cells located at the down stream of the new inserted cells, in an alphabetical and ascending numerical order.

As shown in FIG. 6, the following hierarchical structure cell instances are allotted to the new inserted buffers 213, 223, 233, and 243:

an instance “Chip/A/reg1/cbuf1” to the buffer 213;

an instance “Chip/B/reg1/cbuf2” to the buffer 223;

an instance “Chip/C/reg1/cbuf3” to the buffer 233; and

an instance “Chip/D/reg1/cbuf4” to the buffer 243.

By the above-mentioned hierarchical structure cell instance allotting process, the hierarchical structure cell instances are allotted to all of the cells of the optimized flat layout pattern data 200 shown in FIG. 3.

In the above-mentioned example of the present embodiment, the instance of the cell connected to the new inserted cell at the down stream is quoted in hierarchical structure cell instance allotting of the new inserted cell. When there is a cell connected to the new inserted cell at the upper stream, the instance of the cell may be alternatively quoted.

Moreover, in the above-mentioned example of the present embodiment, when a plurality of cells is connected to the new inserted cell at the down stream, the instance is quoted in an alphabetical and ascending numerical order. The instance may be alternatively quoted in an inverse-alphabetical and descending numerical order, or further alternatively in a character code order.

Furthermore, in the above-mentioned example of the present embodiment, the new inserted cells by the optimizing process are buffers. The new inserted cells by the optimizing process may include cells in which some logic cells are compounded.

### Embodiment 2

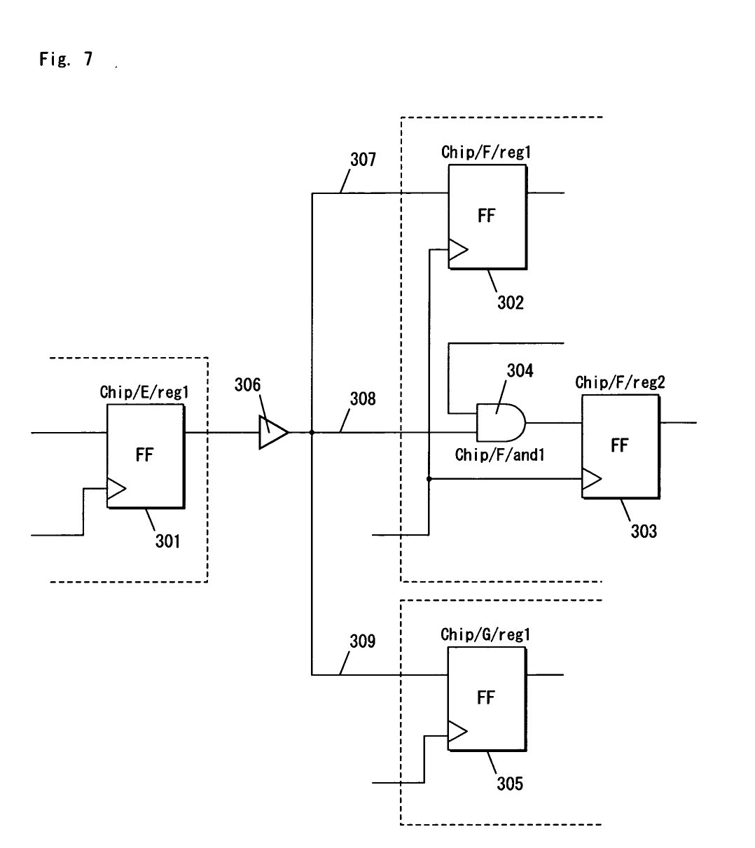

FIG. 7 is a partial exemplified schematic diagram illustrating optimized flat layout pattern data (in an intermediate state) with allotted hierarchical structure cell instance in Embodiment 2 of the present invention.

In the partial exemplified schematic diagram illustrating the flat layout pattern data shown in FIG. 7, the following instances are allotted to the existing cells, by the optimizing process and the hierarchical structure cell instance allotting process:

an instance “Chip/E/reg1” to a flip-flop 301;

an instance “Chip/F/reg1” to a flip-flop 302;

an instance “Chip/F/reg2” to a flip-flop 303;

an instance “Chip/G/reg1” to a flip-flop 305; and

an instance “Chip/F/and1” to an AND circuit 304.

In the partial exemplified schematic diagram illustrating the flat layout pattern data shown in FIG. 7, a buffer 306 is newly inserted by the optimizing process. The output port of the buffer 306 is connected to the flip-flop 302 via a wire 307, to the AND circuit 304 via a wire 308, and to the flip-flop 305 via a wire 309.

The following explains how the cell instance generating method of the present embodiment is applied to the new inserted buffer 306. The cell instance generating method of the present embodiment selects a cell, of which the instance is quoted, among the plurality of cells in the down stream of the new inserted cell, based on the wire length therebetween.

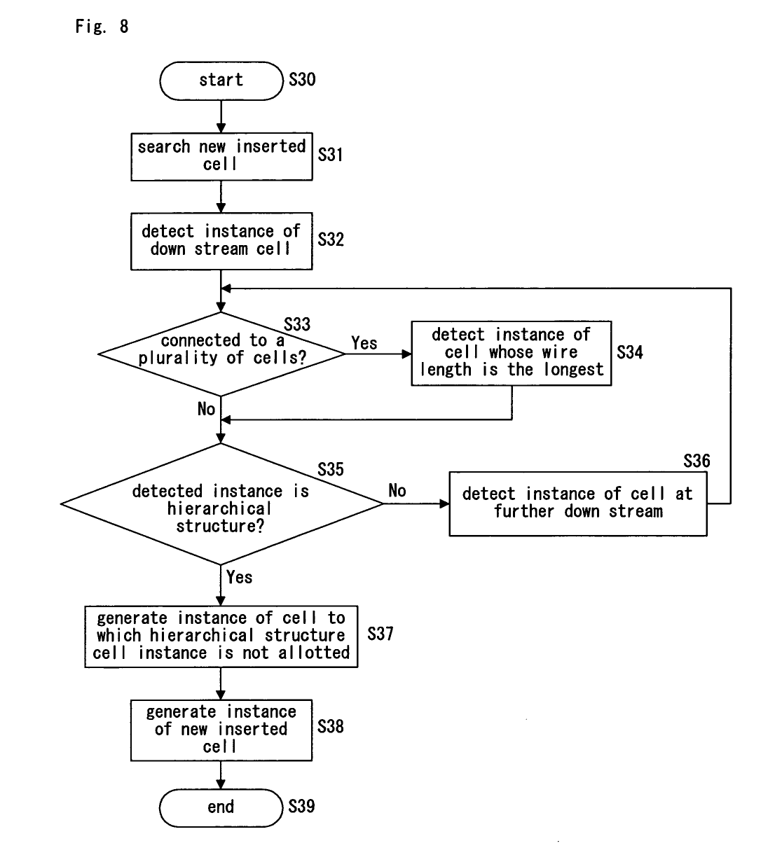

FIG. 8 is a flow chart of cell instance generation in Embodiment 2 of the present invention.

At Step S30 shown in FIG. 8, when the instance generating process starts, a new inserted cell is searched at Step S31.

At Step S32, the instance of a cell in the down stream of the searched new inserted cell is detected.

At Step S33, whether the output port of the new inserted cell is connected to a plurality of cells or not is judged. When the judgment result is “Yes” (it is connected to a plurality of cells), the control moves to Step S34. When the judgment result is “No” (it is not connected to a plurality of cells), the control moves to Step S35.

At Step S34, among the plurality of cells connected to the output port of the new inserted cell, a cell whose wire length to the new inserted cell is the longest is searched, and an instance of the cell is detected. Then, the processing moves to Step S33.

At Step S35, when the plurality of cells are connected to the output port of the new inserted cell, the instance detected at Step S34 is selected. When a single cell is connected to the output port of the new inserted cell, the instance detected at Step S32 is selected. Then, whether the selected instance is hierarchical structure cell instance or not is judged. When the judgment result is “Yes” (it is the hierarchical structure cell instance), the control moves to Step S37. When the judgment result is “No” (it is not the hierarchical structure cell instance), the control moves to Step S36.

At Step S36, a cell at further down stream than the cell of which the instance is judged at step 35 is searched, and an instance of the cell is detected. Then, the control returns to Step S33.

By repeating Step S33 through Step S36, the cell, to which the hierarchical structure cell instance is allotted, is finally reached.

At Step S37, by quoting the hierarchical structure cell instance detected at Step S36, an instance is generated and allotted to the cell, to which the hierarchical structure cell instance has not been allotted yet.

At Step S38, an instance of the new inserted cell is generated and the processing ends at Step S39.

By applying the cell instance generating method to the buffer 306 of FIG. 7 in accordance with the flow chart of FIG. 8, the instance of the buffer 306 is determined as follows. In the present description, it is assumed that the wire length is longer in the order of the wire 307>the wire 308>the wire 309, in FIG. 7.

At Step S31 of FIG. 8, the buffer 306 of FIG. 7 is searched as a new inserted cell.

At Step S33, whether the buffer 306 (the searched new inserted cell) is connected to a plurality of cells or not is judged, and the processing moves to Step S34.

At Step S34, the flip-flop 302, which is a cell connected to the wire 307 having the longest wire length, is selected, and the instance “Chip/F/reg1” of the cell is detected.

At Step S35, since the detected instance “Chip/F/reg1” is the hierarchical structure cell instance, the judgment result is “Yes”. Then, the processing moves to Step S37.

At Step S37, there is no processing to be performed in the present case; therefore, the processing moves to Step S38.

At Step S38, a hierarchical structure cell instance “Chip/F/reg1/dbuf” is generated for the buffer 306 (the new inserted cell).

As described above, when a plurality of cells are connected to the output port of the new inserted cell, the cell instance generating method of the present embodiment selects one cell among the plurality of the cells connected to the output port of the new inserted cell, based on the wire length between the new inserted cell and each of the plurality of the cells, as a judgment criterion.

The above-mentioned judgment criterion may be alternatively decided by “the order of smaller connection capacity”. In this case, “detect instance of cell whose wire length is the longest” of Step S34 of FIG. 8 should be read as “detect instance of cell whose connection capacity is the smallest”. Assume that the magnitude of the connection capacity is in the order of the wire 307=the wire 309>the wire 308, then the wire 308 is selected according to the present judgment criterion, and the cell instance of the AND circuit 304 connecting to the wire 308 is quoted. Finally, a hierarchical structure cell instance “Chip/F/and1/dbuf” is generated for the buffer 306.

As a further alternative, based on both “wire length” and “connection capacity”, the above-mentioned judgment criterion may be decided by “longer wire length and smaller connection capacity”. In FIG. 7, assume that the wire length is in the order of the wire 307=the wire 309>the wire 308, and that the magnitude of the connection capacity is in the order of the wire 309>the wire 307>the wire 308, then the wire 309 is selected according to the present judgment criterion, and the cell instance of the flip-flop 305 connecting to the wire 309 is quoted. Finally, a hierarchical structure cell instance “Chip/G/reg1/dbuf” is generated for the buffer 306.

### Embodiment 3

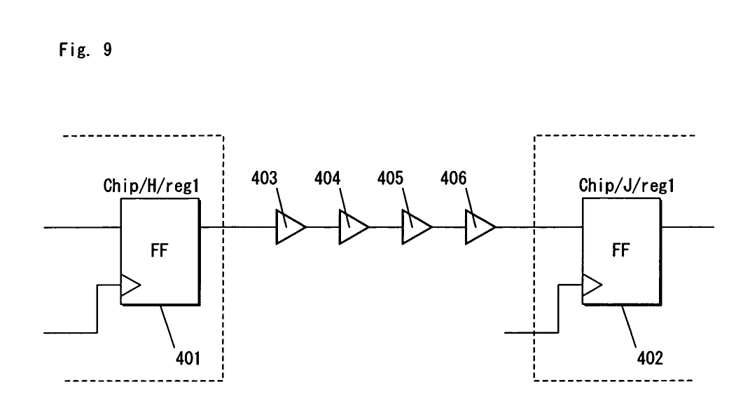

FIG. 9 is a partial exemplified schematic diagram illustrating optimized flat layout pattern data (in an intermediate state) with allotted hierarchical structure cell instance in Embodiment 3 of the present invention.

In the partial exemplified schematic diagram illustrating the flat layout pattern data shown in FIG. 9, the following instances are allotted to the existing cells, after the optimizing process and the hierarchical structure cell instance allotting process:

an instance “Chip/H/reg1” to a flip-flop 401; and

an instance “Chip/J/reg1” to a flip-flop 402.

In the partial exemplified schematic diagram illustrating the flat layout pattern data shown in FIG. 9, buffers 403, 404, 405, and 406, connected each other in chain, are newly inserted for the timing adjustment.

The following explains how the cell instance generating method of the present embodiment is applied to generate instances for the new inserted buffers 403, 404, 405, and 406.

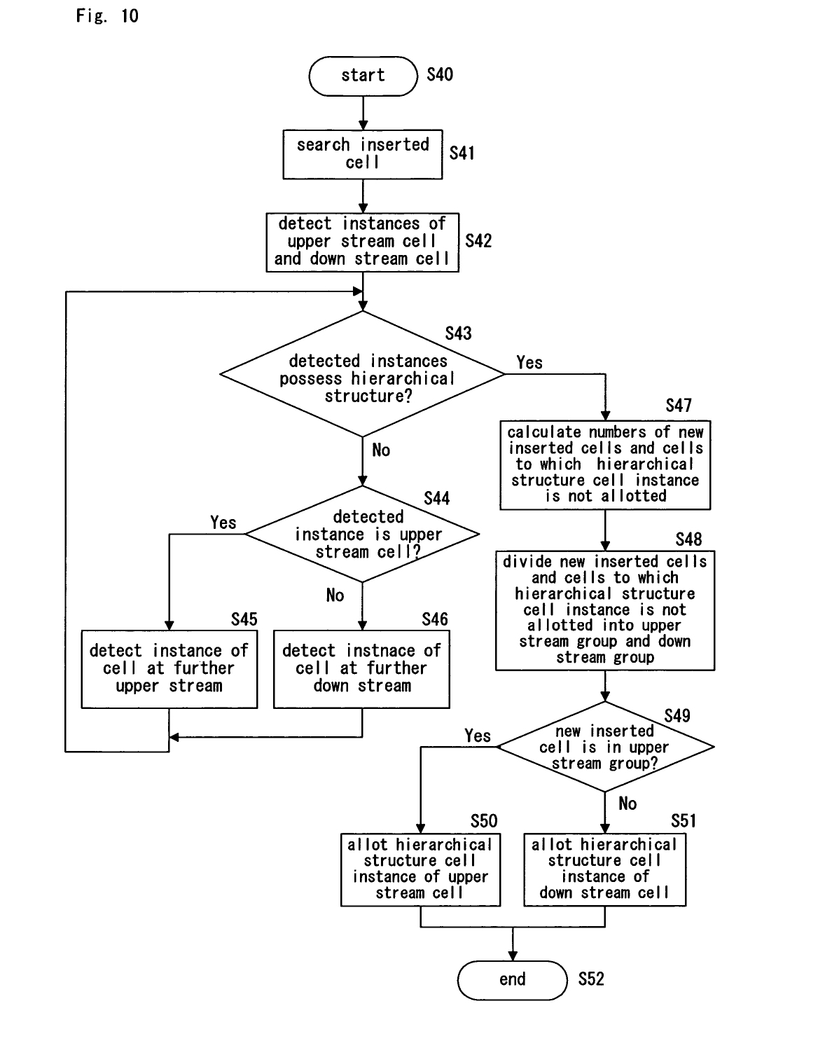

FIG. 10 is a flow chart of the cell instance generation in Embodiment 3 of the present invention.

As shown in FIG. 10, the processing starts at Step S40, and a new inserted cell is searched at Step S41.

At Step S42, instances of cells located in the upper stream and down stream of the newly inserted cell are detected.

At Step S43, whether both of the detected instances of the cells in the upper stream and down stream of the new inserted cell are hierarchical structure cell instances or not is judged. When the judgment result is “Yes” (both of them are a hierarchical structure cell instance), the control moves to Step S47. When the judgment result is “No” (at least one of them is not a hierarchical structure cell instance), the control moves to Step S44.

At Step S44, whether the cell whose instance is judged not a hierarchical structure cell instance is located in the upper stream or the down stream is judged. When the judgment result is “Yes” (the cell is in the upper stream), the control moves to Step S45. When the judgment result is “No” (the cell is in the down stream), the control moves to Step S46.

At Step S45, regarding the upper stream, a cell located at further upper stream than the concerned cell is searched. Then, the instance of the cell is detected, and the control moves to Step S43.

At Step S46, regarding the down stream, a cell located at further down stream than the concerned cell is searched. Then, the instance of the cell is detected and the control moves to Step S43.

By repeating Step S43 to Step S46, for the new inserted cell, a cell having a hierarchical structure cell instance can be reached in both of the upper stream and the down stream of the new inserted cell.

At Step S47, the number of the new inserted cells and the number of the cells to which the hierarchical structure cell instance is not allotted are calculated.

At Step S48, the new inserted cells and the cells to which the hierarchical structure cell instance is not allotted are divided into an upper stream group and a down stream group at a predetermined ratio.

At Step S49, whether the new inserted cell belongs to the upper stream group or to the down stream group is judged. When the judgment result is “Yes” (the new inserted cell belongs to the upper cell), the control moves to Step S50. When the judgment result is “No” (the new inserted cell belongs to the down stream), the control moves to Step S51.

At Step S50, quoting the hierarchical structure cell instance of the cell at the upper stream, detected at Step S45, the instance of the new inserted cell is generated. The processing moves to Step 52 to end.

At Step S51, quoting the hierarchical structure cell instance of the cell at the down stream, detected at step S46, the instance of the new inserted cell is generated. The processing moves to Step 52 to end.

According to the flow chart of FIG. 10, the cell instance generating method of the present embodiment is applied to the buffer 404 of FIG. 9, then, the instance of the buffer 404 is determined as follows. In the present example, the new inserted cells are the four buffers 403 to 406. It is assumed that there is no cell, except for the new inserted cells, to which the hierarchical structure cell instance is not allotted. It is also assumed that the division ratio of the upper stream group and the down stream group of the chained cells is set to 50%-50%.

In the following explanation, as for the buffer 403, it is assumed that the cell instance allotting process is already completed, and an instance “Chip/H/reg1/dbuf1” is generated as the cell instance.

At Step S41 of FIG. 10, the buffer 404 of FIG. 9 is searched as a new inserted cell for processing.

At Step S42, the instance “Chip/H/reg1/dbuf1” of the cell (the buffer 403) located in the upper stream of the buffer 404 is detected, and an instance “dbuf3” of the cell (the buffer 405) located in the down stream is detected.

At Step S43, whether the hierarchical structure cell instance is allotted to the detected instances or not is judged. In the example of the present embodiment, the hierarchical structure cell instance is allotted to the cell in the upper stream, but not to the cell in the down stream. Therefore, the judgment result is “No.”

At Step S44, the cell to which the hierarchical structure cell instance is not allotted is judged one in the down stream, and the control moves to Step S46.

At Step S46, an instance of a cell at the further down stream of the buffer 405 is detected, that is, an instance “dbuf4” of the buffer 406. Then, the control returns to Step S43.

The processing of Step S43 to Step S46 is performed again, and a hierarchical structure cell instance “Chip/J/reg1” is eventually detected for a cell (a flip-flop 402) at the further down stream at Step S46.

As a result, the judgment result of Step S43 becomes “Yes”, and the control moves to Step S47.

At Step S47, the number of the new inserted cells and the number of the cells to which a hierarchical structure cell instance is not allotted are calculated to be four and zero, respectively.

At Step S48, the four new inserted cells are divided into the upper stream group (the buffer 403 and the buffer 404) and the down stream group (the buffer 405 and the buffer 406) at the predetermined division ratio (50%-50%).

At Step S49, the buffer 404, which is the new inserted cell to be processed, is judged to belong to the upper stream group, and the control moves to Step S50.

At Step S50, an instance “Chip/H/reg1/dbuf1/dbuf2” is generated as the cell instance of the buffer 404, quoting the hierarchical structure cell instance of the cell at the upper stream, or the buffer 403.

The similar cell instance generation is also performed to the other new inserted cells. As a result, the following hierarchical structure cell instances are finally generated for the four new inserted cells shown in FIG. 9:

an instance “Chip/H/reg1/dbuf1” to the buffer 403;

an instance “Chip/H/reg1/dbuf1/dbuf2” to the buffer 404;

an instance “Chip/J/reg1/dbuf4/dbuf3” to the buffer 405; and

an instance “Chip/J/reg1/dbuf4” to the buffer 406.

As explained above, according to the cell instance generating method of the present embodiment, the hierarchical structure cell instance can be uniquely generated to a plurality of cells inserted in chain.

### Embodiment 4

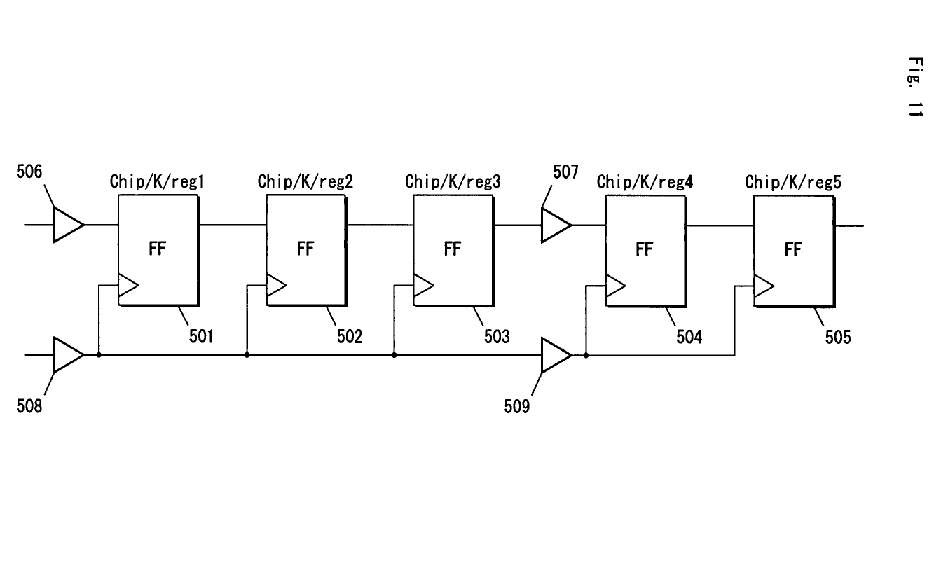

FIG. 11 is a partial exemplified schematic diagram illustrating optimized flat layout pattern data (in an intermediate state) with allotted hierarchical structure cell instance in Embodiment 4 of the present invention.

In the partial exemplified schematic diagram illustrating the flat layout pattern data shown in FIG. 11, after the optimizing process and the hierarchical structure cell instance allotting process, the following instances are already allotted to the exiting cells, that is:

an instance “Chip/K/reg1” to a flip-flop 501;

an instance “Chip/K/reg2” to a flip-flop 502;

an instance “Chip/K/reg3” to a flip-flop 503;

an instance “Chip/K/reg4” to a flip-flop 504; and

an instance “Chip/K/reg5” to a flip-flop 505.

Moreover, in the partial exemplified schematic diagram illustrating the flat layout pattern data shown in FIG. 11, after the optimizing process, buffers 506 and 507 are newly inserted for timing adjustment and improvement of drive capability, and buffers 508 and 509 are newly inserted for clock skew adjustment.

In the cell instance generating method of the present embodiment, for generating the instance of the new inserted cells, the cell possessing the hierarchical structure cell instance to be quoted is selected according to the following judgment criteria.

(1) When at least one of the cell groups located in the upper stream and down stream of the new inserted cell possesses a plurality of cells, a cell group that has more cells than the other cell group is selected and an instance of a cell included in the group is quoted.

(2) When both cell groups possess the same number of cells, the cell group located in the down stream is selected, and an instance of a cell included in the group is quoted.

(3) The instance is quoted in an alphanumeric order.

According to the above judgment criteria, the following hierarchical structure cell instances are generated for the four new inserted cells of FIG. 11, that is:

an instance “Chip/K/reg1/dbuf1” to the buffer 506;

an instance “Chip/K/reg4/dbuf2” to the buffer 507;

an instance “Chip/K/reg1/cbuf1” to the buffer 508; and

an instance “Chip/K/reg1/cbuf2” to the buffer 509.

Here, the following point should be noted in generating the cell instance for the buffer 509. The cell group located in the upper stream of the buffer 509 possesses four cells including the flip-flops 501, 502, and 503, and the buffer 508. The cell group located in the down stream of the buffer 509 possesses two cells including the flip-flops 504 and 505. According to the first judgment criterion, the cell group located in the upper stream of the buffer 509 is selected, and according to the third judgment criterion, the instance of the flip-flop 501 is quoted among the instances of the four cells in the group; thereby generating the instance of the buffer 509. The quoted hierarchical structure cell instance is the instance “Chip/K/reg1” of the flip-flop 501, and the generated hierarchical structure cell instance for the buffer 509 is the instance “Chip/K/reg1/cbuf2”.

As for the buffer 507, since the numbers of cells included in the cell group in the upper stream and in the cell group in the down stream are equal; therefore, according to the second judgment criterion, the cell group in the down stream is selected, and the hierarchical structure cell instance “Chip/K/reg4” of the flip-flop 504 is quoted and the hierarchical structure cell instance “Chip/K/reg4/dbuf2” is generated for buffer 507.

According to the cell instance generating method of the present invention, it is possible to allot an instance indicating hierarchical structure, when performing the optimizing process using the flat layout pattern data alone. In other words, without generating the other data or performing comparison process etc., any cell is rendered detectable in a unit of hierarchical structure, by specifying the instance included in the net list generated from the flat layout pattern data. Therefore, when the cell instance generating method of the present invention is applied to a large-scale integrated circuit, area calculation and power consumption analysis in a unit of hierarchical structure becomes possible, using the net list.

According to the present invention, for the layout pattern data possessing hierarchical structure, an instance indicating hierarchical structure can be accurately and uniquely allotted to new cells inserted as the result of optimizing the flat layout pattern data. As explained above, the point of the present invention is to provide the cell instance generating method operable to generate and allot a cell instance uniquely to a cell included in the flat layout pattern data; therefore, as long as it falls within the scope of the present invention, various changes can be made.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A cell instance generating method comprising:
developing data of a hierarchically constructed layout pattern into data of cells, thereby generating data of a flat layout pattern including the data of cells;
optimizing the data of the flat layout pattern, thereby generating data of an optimized flat layout pattern including a newly inserted first cell having an input port and an output port, wherein the input port of the first cell is connected to a second cell of the optimized flat layout pattern, wherein the output port of the first cell is connected to a third cell of the optimized flat layout pattern, and wherein at least one of the second cell and the third cell has a hierarchical structure cell instance indicating a hierarchical structure thereof;
quoting either of the hierarchical structure cell instance of the second cell or the hierarchical structure cell instance of the third cell, thereby generating a cell instance to be allotted to the first cell; and
allotting the generated cell instance to the first cell.

2. The cell instance generating method as defined in claim 1, wherein when the second cell does not possess a hierarchical structure cell instance, said quoting includes quoting a cell instance of a further upper stream cell, thereby generating a cell instance to be allotted to the first cell.

3. The cell instance generating method as defined in claim 1, wherein when the third cell does not possess a hierarchical structure cell instance, said quoting includes quoting a cell instance of a further down stream cell, thereby generating a cell instance to be allotted to the first cell.

4. A cell instance generating method comprising:
developing data of a hierarchically constructed layout pattern into data of cells, thereby generating data of a flat layout pattern including the data of cells;
optimizing the data of the flat layout pattern, thereby generating data of an optimized flat layout pattern including a newly inserted first cell group having an input port and an output port, wherein the input port of the first cell group is connected to a second cell group of the optimized flat layout pattern, wherein the output port of the first cell group is connected to a third cell group of the optimized flat layout pattern;
quoting either of a hierarchical structure cell instance of a cell belonging to the second cell group or a hierarchical structure cell instance of a cell belonging to the third cell group, thereby generating a cell instance to be allotted to a cell belonging to the first cell group; and
allotting the generated cell instance to the cell belonging to the first cell group.

5. The cell instance generating method as defined in claim 4, wherein when at least one of the second cell group and the third cell group is composed of a plurality of cells connected to the first cell group, said quoting includes quoting a hierarchical structure cell instance of a cell chosen from the plurality of cells in accordance with a predetermined rule, thereby generating a cell instance to be allotted to a cell belonging to the first cell group.

6. The cell instance generating method as defined in claim 5, wherein the predetermined rule includes a rule quoting a hierarchical structure cell instance from a plurality of hierarchical structure cell instances of the plurality of cells, in accordance with at least one of an alphabetical order, a numerical order, and a character code order.

7. The cell instance generating method as defined in claim 5, wherein the predetermined rule includes a rule quoting a hierarchical structure cell instance of a cell of the plurality of cells, in accordance with at least one of a wire length and a connection capacity between the first cell group and the cell of the plurality of cells.

8. The cell instance generating method as defined in claim 5, wherein the predetermined rule includes choosing either of the second cell group and the third cell group based on a number of cells included therein and quoting a hierarchical structure cell instance of a cell belonging to the chosen cell group.

9. The cell instance generating method as defined in claim 4, wherein when the first cell group is composed of a plurality of cells chained one another, said quoting includes:
dividing the plurality of cells composing the first cell group into an upper stream group and a down stream group at a predetermined ratio;
quoting a hierarchical structure cell instance of a cell belonging to the second cell group, thereby generating a cell instance to be allotted to a cell belonging to the upper stream group; and
quoting a hierarchical structure cell instance of a cell belonging to the third cell group, thereby generating a cell instance to be allotted to a cell belonging to the down stream group.
